(19) United States
(12) Patent Application Publication
(10) Pub. No.: US 2015/0210244 A1
(43) Pub. Date: Jul. 30, 2015

(54) ADAPTABLE VEHICLE SEAT BELT EXTENSION SYSTEM

(71) Applicant: Y. BACK SAFETY SOLUTIONS LTD, Beitar Ilit (IL)

(72) Inventor: YAAKOV MORDECHAI BACK, BEITAR ILIT (IL)

(21) Appl. No.: 14/604,730

(22) Filed: Jan. 25, 2015

(30) Foreign Application Priority Data
Jan. 28, 2014 (IL) 230678

(51) Int. Cl. B60R 22/10; B60R 22/26

(52) U.S. Cl. CPC B60R 22/105; B60R 22/26; B60R 2022/1806

(57) ABSTRACT

The present invention provides a vehicle seat belt extension system including a first seat belt apparatus comprising a first male seat belt clasp connected via a first belt to a first female receiver and via a second belt to a second male seat belt clasp and a second seat belt apparatus comprising a third male seat belt clasp connected via a third belt to a second female receiver and via a fourth belt to a third female receiver, wherein the second male clasp is adapted to engage the second female receiver and the first and third female receivers are each adapted to receive an installed vehicle male clasp, thereby enabling the legal seat-belting of at least four individuals in the rear of the vehicle.

### FIELD OF THE INVENTION

The present invention relates generally to seat belt extensions for vehicles, and more specifically to seat belt extension systems for multiple persons in vehicles.

### BACKGROUND OF THE INVENTION

Most land vehicles, such as cars have a limited number of places for individuals. Typical saloon cars/sedan cars/automobiles are designed to carry five people (two in front and three on the rear seat) and station wagons/estate/minivans are designed to carry seven to ten people. Typically, insurance policies cover an equal number of people as the number of seat belts installed in the car.

Many families have a number of babies and/or infants and/or children. Local traffic law often requires that all individuals under the age of ten/under a minimum weight threshold (45 kg, in some countries) be seated in a rear seat. Baby car seats must be on the rear seat in many countries. Very often, the use of two baby car seats leaves little room for a third passenger on a rear seat.

Many families run school/kindergarten car pools with neighbors and friends, which requires transportation of four to ten children. This poses a legal/practical and insurance problem for parents/drivers, who own saloon/sedan cars.

Israel Patent application no. 225585 describes a vehicle expander booster bench systems and methods, the systems including a bench adapted to accommodate at least four individuals and at least four seat belt devices wherein the system enables the legal seating of the at least four individuals in the rear of the vehicle.

There thus remains an urgent need to provide seat belt extension systems alongside vehicle expander seats which provide safe, insured vehicle seating for more than three children.

### SUMMARY OF THE INVENTION

It is an object of some aspects of the present invention vehicle seat belt extension systems which can safely seat more than three children.

In some embodiments of the present invention, improved seat belt extension systems are provided for seating four or more children on a rear car seat/bench.

In further embodiments of the present invention, improved seat belt extension systems are provided for seating five or more children on a rear car seat/bench.

In other embodiments of the present invention, a method and system is described for providing safe seat belt extension systems for four or more children in the rear part of a vehicle.

There is thus provided according to an embodiment of the present invention, a vehicle seat belt extension system including;
a. a first seat belt apparatus comprising a first male seat belt clasp connected via a first belt to a first female receiver and via a second belt to a second male seat belt clasp;
b. a second seat belt apparatus comprising a third male seat belt clasp connected via a third belt to a second female receiver and via a fourth belt to a third female receiver;

wherein the second male clasp is adapted to engage the second female receiver and the first and third female receivers are each adapted to receive an installed vehicle male clasp, thereby enabling the legal seat-belting of at least four individuals in the rear of the vehicle.

Moreover, according to an embodiment of the present invention, the individuals are under ten years old.

Furthermore, according to an embodiment of the present invention, the seat belt extension system is adapted for use with a bench extension to be placed on the rear seats in the vehicle.

Additionally, according to an embodiment of the present invention, wherein the bench extends sideways beyond the rear seats in the vehicle.

Further, according to an embodiment of the present invention, the bench extends vertically at least five centimeters above the rear seats.

Yet further, according to an embodiment of the present invention, the seat belt extension system is not provided with the vehicle.

Furthermore, according to an embodiment of the present invention, the seat belt extension system is integrated into a vehicle expander booster bench system.

There is thus provided according to another embodiment of the present invention, a method for expanding the number of individuals legally seated in a vehicle, the method including;
a. attaching a vehicle expander booster bench system as described herein to rear seats of a vehicle;
b. seating at least four individuals on the bench in the rear of the vehicle; and
c. strapping each of the at least four individuals into at least two seat belt apparatus built into the vehicle and to the vehicle seat belt extension system to enable the legal seat-belting of at least four individuals in the rear of the vehicle.

Additionally, according to an embodiment of the present invention, the vehicle is a sedan/saloon car and the number of individuals legally seated is at least six.

Furthermore, according to an embodiment of the present invention, the vehicle is a sedan/saloon car and the number of individuals legally seated is at least seven.

Moreover, according to an embodiment of the present invention, the vehicle is an estate/minivan car and the number of individuals legally seated is at least eight.

Furthermore, according to an embodiment of the present invention, the vehicle is an estate/minivan car and the number of individuals legally seated is at least nine.

Additionally, according to an embodiment of the present invention, the vehicle is an estate/minivan car and the number of individuals legally seated is at least ten.

Moreover, according to an embodiment of the present invention, the vehicle is an estate/minivan car and the number of individuals legally seated is at least eleven.

Further, according to an embodiment of the present invention, the vehicle is an estate/minivan car and the number of individuals legally seated is at least twelve.

Yet further, according to an embodiment of the present invention, the vehicle is an estate/minivan car and the number of individuals legally seated is at least thirteen.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified pictorial illustration showing a vehicle seat belt extension system, in accordance with an embodiment of the present invention; and

FIG. 2 is a simplified schematic illustration showing details of a four-seater vehicle expander booster bench system without the vehicle seat belt extension system of FIG. 1, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

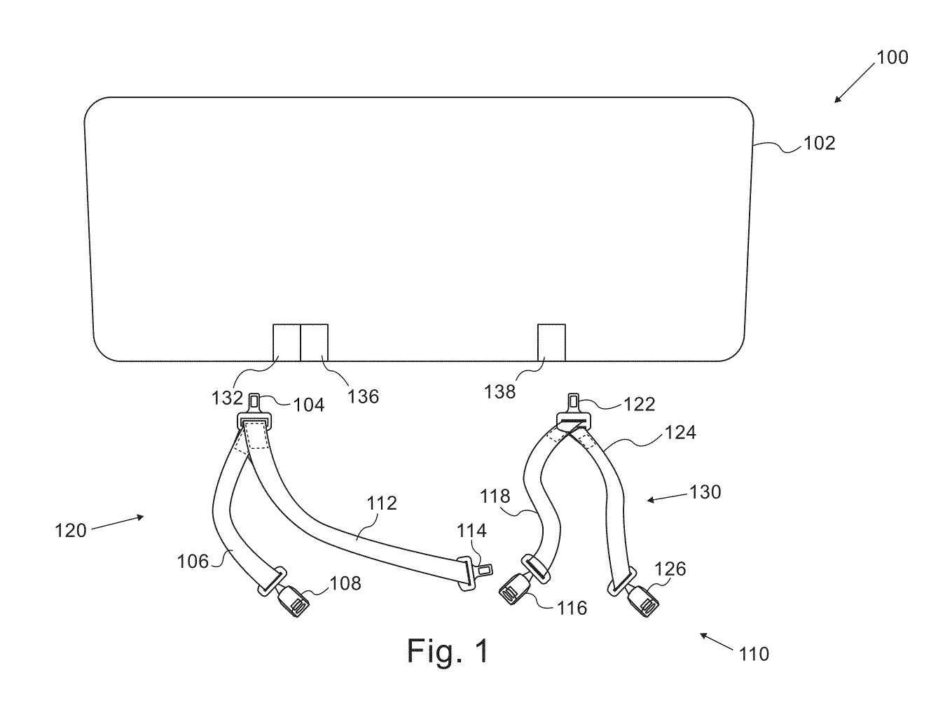

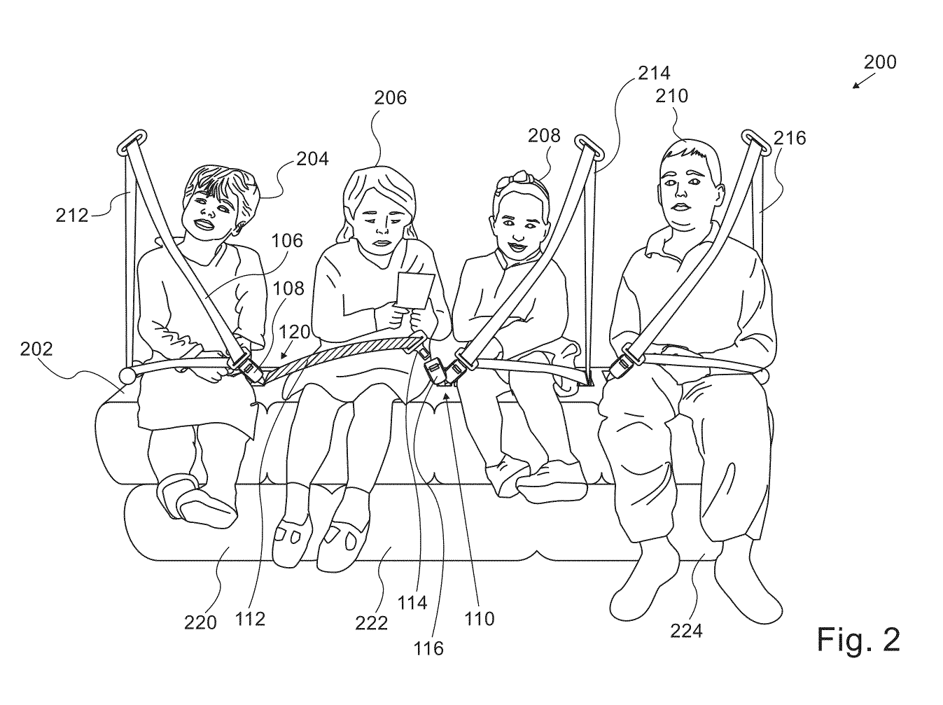

Reference is now made to FIG. 1, which is a simplified pictorial illustration showing a booster seat 102 and vehicle seat belt extension system 100, in accordance with an embodiment of the present invention. A rear bench 102 of a vehicle, such as a saloon car, typically comprises three seats 220, 222 and 224 (FIG. 2). Typically, a car has a width of under two meters and a rear seat width of 130-180 cm.

The present invention comprises vehicle seat belt extension system 110, used in conjunction with a vehicle expander booster bench system 102 adapted to accommodate at least four individuals and at least three seat belt devices 212, 214, 216 which are original seat belt devices belonging to the vehicle. However, since the bench is adapted to accommodate four or more individuals, at least one additional seat belt device is required.

The vehicle seat belt extension system 110 of the present invention is adapted to fill this need.

The vehicle expander booster bench belt system 102 may be similar or identical to those described in Israel Patent application no. 225585 and shown therein in FIGS. 1, 2 and 3, incorporated herein by reference. Additionally or alternatively, the booster seat system may that described in WO10045685A or US2008018150.

The vehicle seat belt extension system 110 of the present invention comprises a first seat belt apparatus 120 and a second seat belt apparatus 120. First seat belt apparatus 120 comprises a first male seat belt clasp 104 connected via a first belt 106 to a first female receiver 108 and via a second belt 112 to a second male seat belt clasp 114.

The second seat belt apparatus comprises a third male seat belt clasp 122 connected via a third belt 118 to a second female receiver 116 and via a fourth belt 124 to a third female receiver 126.

The seat belt system of the present invention comprises belts, receivers and clasps made of materials known in the art and meeting the local safety requirements and standardized dimensions, colors and performance requirements.

The vehicle seat belt extension system 110 is constructed and configured such that the second male clasp 114 is adapted to engage the second female receiver 116 and the first and third female receivers 108, 126 are each adapted to receive an installed vehicle male clasp 213, 217 (FIG. 2), thereby enabling the legal seat-belting of at least four individuals in the rear of the vehicle.

According to some embodiments of the present invention, the vehicle is selected from the group consisting of a land vehicle, water vehicle and an airborne vehicle.

Furthermore, according to some embodiments of the present invention, the land vehicle is selected from the group consisting of a car, a minivan, a truck, a coach, a bus, an emergency vehicle and an army vehicle.

Additionally, according to some embodiments of the present invention, the water vehicle is selected from the group consisting of a boat, a yacht, a ship, an emergency water vehicle and an army water vehicle.

The term “air vehicle” is meant herein to broadly include any vehicle which travels in the air, typically by flight. Some non-limiting examples of air vehicles include a glider, an airplane, a helicopter, an airship, a spaceship or shuttle, a rocket, an emergency air vehicle and an army air vehicle.

Reference is now made to FIG. 2A, which is a simplified schematic illustration 200 showing details of a four-seater vehicle expander booster bench system 202 without the vehicle seat belt extension system 110 of FIG. 1, in accordance with an embodiment of the present invention.

As can be seen in FIG. 2A, bench system 202 extends sideways beyond the sides of the three car seats 220, 222 and 224.

As can be seen in FIG. 2, bench system 202 is constructed and configured to seat at least four individuals 204, 206, 208, 210. The original vehicle is normally provided with three seat belt devices 212, 214 and 216.

However, if there are four individual, one additional seat belt device is required.

As can be seen in FIG. 2, all four individuals 204, 206, 208 and 210 are properly secured in position with seatbelt devices.

The vehicle seat belt extension system 110 may be arranged and connected to the original vehicle seat belt devices and receptacles in a number of ways and the example presented herein should not be deemed as limiting.

Individual 204 is secured with original seatbelt device 212 having a male clasp 213 inserted into female receiver 108 of the first seat belt apparatus 120. The female receiver is connected via belt 106 to first male seat belt clasp 104 which is inserted into original vehicle female receiver 215.

The second individual 206 is secured via original seat belt device 214 with his abdomen being secured by belt 112 of vehicle seat belt extension system 110, which, in turn has second male seat belt clasp 114 inserted into the second female receiver 116 of second seat belt apparatus 130.

The third individual 208 is secured on his abdomen via third belt 118 and third male seat belt clasp 122 into original vehicle receiver (also called receptacle) 217.

The fourth individual 210 is secured by original seat belt device 216 connecting via the third female receiver 126 via fourth belt 124 and third male seat belt clasp 122 into original vehicle receiver (also called receptacle) 217.

The terms “plurality” or “a plurality” as used herein include, for example, “multiple” or “two or more”. For example, “a plurality of items” includes two or more items.

The booster bench 202 described herein may be made of a piece of dense foam covered in a fabric. The booster benches described herein are typically of the following general dimensions: length 100-180 cm, width 30-60 cm and height 5-12 cm.

The foam is typically of a density of 1.95-2.05 pounds per cubic foot with the compression of 67-73 pounds and must pass the local flammability requirements.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A vehicle seat belt extension system comprising:
a. a first seat belt apparatus comprising a first male seat belt clasp connected via a first belt to a first female receiver and via a second belt to a second male seat belt clasp; and
b. a second seat belt apparatus comprising a third male seat belt clasp connected via a third belt to a second female receiver and via a fourth belt to a third female receiver;
wherein the second male clasp is adapted to engage the second female receiver and the first and third female receivers are each adapted to receive an installed vehicle male clasp, thereby enabling the legal seat-belting of at least four individuals in the rear of the vehicle.

2. A vehicle seat belt extension system according to claim 1, wherein at least one of said first male seat belt clasp and said a third male seat belt clasp are adapted to be inserted in a female receptacle of said vehicle.

3. A vehicle seat belt extension system according to claim 3, wherein both said first male seat belt clasp and said a third male seat belt clasp are adapted to be inserted in a female receptacle of said vehicle.

4. A vehicle seat belt extension system according to claim 1, wherein said according to claim 1, wherein said bench is adapted to accommodate at least five individuals.

5. A vehicle seat belt extension system according to claim 1, wherein said belt extension system is used in conjunction with a vehicle expander booster bench system.

6. A vehicle seat belt extension system according to claim 5, wherein said individuals are under ten years old.

7. A vehicle seat belt extension system according to claim 5, wherein said bench is adapted to be placed on the rear seats in said vehicle.

8. A method for expanding the number of individuals legally seated in a vehicle, the method comprising:
a. attaching a vehicle expander booster bench system to rear seats of a vehicle;
b. seating at least four individuals on said bench in the rear of said vehicle; and
c. strapping each of said at least four individuals into at least one of part of said vehicle seat belt extension system and a vehicle seat belt device.

9. A method according to claim 8, wherein said vehicle is a sedan/saloon car and the number of individuals legally seated is at least six.

10. A method according to claim 8, wherein said vehicle is a sedan/saloon car and the number of individuals legally seated is at least seven.

11. A method according to claim 8, wherein said vehicle is an estate/minivan car and the number of individuals legally seated is at least eight.

12. A method according to claim 8, wherein said vehicle is an estate/minivan car and the number of individuals legally seated is at least nine.

13. A method according to claim 8, wherein said vehicle is an estate/minivan car and the number of individuals legally seated is at least ten.

14. A method according to claim 8, wherein said vehicle is an estate/minivan car and the number of individuals legally seated is at least eleven.
